(19) United States
(12) Patent Application Publication
(10) Pub. No.: US 2025/0138859 A1
(43) Pub. Date: May 1, 2025

(54) MIGRATING CONTAINER WORKLOADS IN EDGE COMPUTING SYSTEMS BASED ON ENERGY CONSUMPTION

(71) Applicant: RED HAT, INC., Raleigh, NC (US)

(72) Inventors: Leigh Griffin, Waterford (IE); Aoife Elizabeth Moloney, Waterford (IE)

(21) Appl. No.: 18/499,428

(22) Filed: Nov. 1, 2023

(51) Int. Cl. G06F 9/455

(52) U.S. Cl. CPC G06F 9/45558; G06F 2009/4557

(57) ABSTRACT

Container workloads can be transferred (e.g., migrated) between nodes of a distributed computing environment based on energy consumption. For example, a system may generate an energy consumption estimate for a container executing on a first node. The system can further determine that the energy consumption estimate of the container exceeds an energy consumption threshold. In response, the system may implement a multi-objective optimization algorithm to identify a second node usable to execute the container. The multi-objective optimization algorithm may identify the second node based on current workloads of a group of nodes that includes the second node and the energy consumption estimate of the container. The system may then deploy the container at the second node.

### TECHNICAL FIELD

The present disclosure relates generally to container migration and, more particularly (although not necessarily exclusively), to migrating container workloads based on energy consumption.

### BACKGROUND

Distributed computing systems (e.g., cloud computing systems, data grids, and computing clusters) have recently grown in popularity given their ability to improve flexibility, responsiveness, and speed over conventional computing systems. In some cases, the responsiveness and speed of distributed computing systems can be further improved by employing edge computing solutions. Edge computing is a networking philosophy focused on bringing computing power and data storage as close to the source of the data as possible to reduce latency and bandwidth usage. In general, edge computing can involve executing services on nodes that are positioned at the physical edges of a distributed computing system. Examples of such services may include data-processing services and data-storage services. Positioning the nodes at the physical edges of the distributed computing system can result in the nodes being physically closer to the client devices that provide data to the distributed computing system. This relatively close physical proximity of the edge nodes to the client devices can reduce latency and improve the perceived quality of the services.

### BRIEF DESCRIPTION OF THE DRAWINGS

FIG. 1 is a block diagram of an example of a distributed computing environment for migrating container workloads based on energy consumption according to some aspects of the present disclosure.

FIG. 2 is a block diagram of another example of a distributed computing environment for migrating container workloads based on energy consumption according to some aspects of the present disclosure.

FIG. 3 is a flowchart of a process for migrating container workloads based on energy consumption according to some aspects of the present disclosure.

### DETAILED DESCRIPTION

Current systems can deploy containers in energy-constrained environments, such as on edge devices. For example, a container may be deployed at an edge device to retrieve data from data sources within an access range of the edge device. The energy-constrained environments can be characterized by limited energy (e.g., electrical power) and computing resources. For example, the edge device may be battery powered and may have limited central processing unit (CPU) power, memory, and storage. Container deployment and execution at edge devices consumes computing resources and electrical energy of the edge devices, and therefore may negatively affect the edge devices. For example, deployment of a container at an edge device with insufficient energy level (e.g., battery power) may cause the edge device to power off. Additionally, if an edge device has insufficient computing resources available for a container, deployment of the container at the edge device may strain the computing resources. As a result, workloads of the container can exhibit poor performance (e.g., latency in data retrieval or processing). Straining the computing resources can further increase energy consumption by the container at the edge device, thereby increasing a total energy consumption of the distributed computing environment with the edge device. The increase in energy consumption can also decrease a battery life of the edge device.

Computing resource and energy requirements of containers can further be variable. For example, an increase in a volume of users or network traffic can increase energy and computing resource requirements of the container. The computing resources available to the container can also be variable. For example, other workloads employed at an edge device can consume computing resources. Thus, performance of a container at an edge device can degrade over time or within certain time periods (e.g., a time period corresponding high network traffic).

Some examples of the present disclosure overcome one or more of the abovementioned problems via a migration mechanism that can migrate containers to facilitate energy-efficient deployment and execution of containers at nodes (e.g., edge devices) in a distributed computing environment. To do so, the migration mechanism may estimate energy consumption by the containers relative to the nodes on which the container may be deployed. For example, an energy consumption estimate for a container can be a prediction of an amount of electrical power consumed by a group of containerized applications or workloads of the container when executed at a particular node. The energy consumption estimate for the container can be based on CPU usage, memory consumption, a volume of clients, network traffic, or other suitable aspects of container execution that impact energy consumption. By considering the various aspects of container execution that impact energy consumption, the migration mechanism can accurately estimate energy consumption by the container (e.g., as opposed to the energy consumption of the node as a whole).

The migration mechanism can further determine node characteristics (e.g., energy levels, workload conditions such as predicted workloads or current workloads, and computing resource availability) associated with the nodes. The migration mechanism can then implement, for example, a multi-objective optimization algorithm to schedule container operations (e.g., deployment) based on the node characteristics and the energy consumption estimates of the containers. In this way, container operations, energy consumption at the nodes by the containers, and overall energy consumption of the distributed computing environment can be optimized.

Additionally, the migration mechanism may monitor energy consumption by containers and adjust container operations to prioritize energy efficiency. For example, the migration mechanism can detect spikes in energy consumption by containers, overloading of containers, or issues (e.g., low battery or strained computing resources) with nodes. In response, the migration mechanism can transfer workloads of the containers to maintain energy-efficiency and workload performance. In some examples, the workloads of a container may be transferred to containers with lower energy or computing resource requirements. Additionally, or alternatively, containers may be transferred to nodes with more battery power or available computing resource. Energy consumption by containers can be decreased as a result of transferring the workloads.

In one particular example, a container that includes a set of API contracts can be executing at an edge device (e.g., a sensor unit of an autonomous vehicle). The API contracts can define communication protocols between the edge device and data services. Executing the container can enable the edge device to retrieve data from the data services. While executing the container, a system may determine an energy consumption estimate for the container. For example, the container can be consuming five percent of the edge device's total energy per hour, which may exceed an energy consumption threshold for the edge device.

As a result of determining that the energy consumption estimate exceeds the energy consumption threshold, the system can evaluate energy levels, current workloads, predicted workloads, and available computing resources of other suitable edge devices. The system can then identify another edge device (e.g., another sensor unit) that is compatible with the container. For example, the system can implement a multi-objective optimization algorithm to predict at which edge device energy consumption by the container can be minimized while optimizing one or more performance metrics of the container. The multi-object optimization algorithm can take the energy levels, predicted workloads, current workloads, and available computing resources of the other suitable edge devices as inputs. The multi-objective optimization function can also take the energy consumption estimate of the container as an input.

The multi-objective optimization function can then predict energy consumption by the container at each edge device and the performance metrics (e.g., memory usage, CPU usage, or response times) of the container at each edge device. The output of the multi-objective optimization function can then be whichever edge device corresponds to the best result (e.g., energy consumption and performance metrics) among the edge devices analyzed, where the “best” result is whichever result most closely satisfies the objective functions of the multi-objective optimization function subject to its constraints. The multi-objective optimization algorithm can include any number of constraints. For example, the multi-objective optimization algorithm can take an energy level threshold as a constraint. Other constraints may indicate computing resource requirements (e.g., CPU power or storage space) for the container. As a result, the edge device output by the multi-objective optimization function can be whichever edge device minimizes energy consumption, optimizes performance metrics, and satisfies the constraints, such as by having an energy level (e.g., battery life) that meets or exceeds the energy level threshold and having sufficient computing resources available for the container.

In response to identifying the particular edge device, the system can securely migrate the container to the particular edge device. This migration may involve transferring runtime configurations and data of the container to the particular edge device. The container can then be executed at the particular edge device with minimal disruption to the retrieval of data from the data services.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

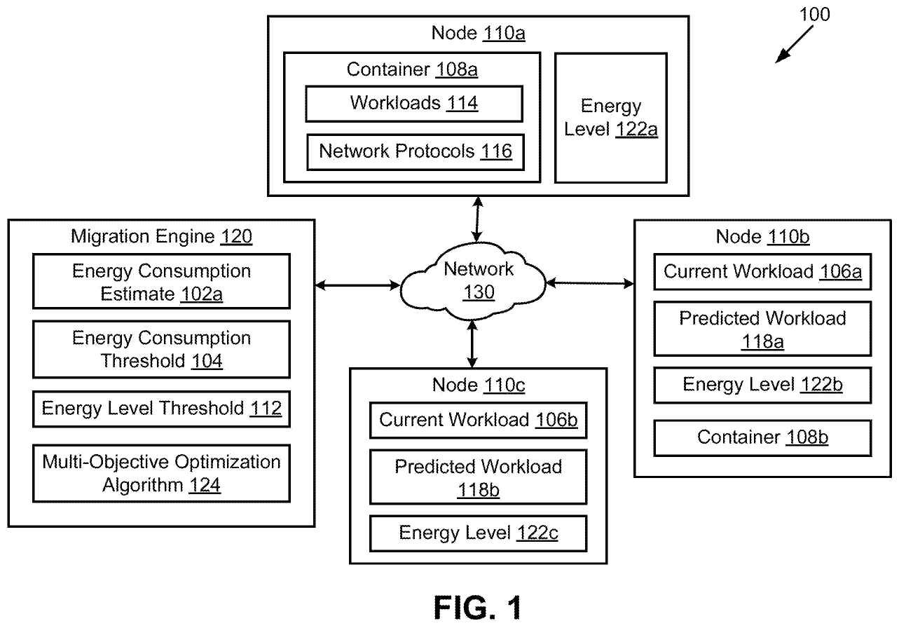

FIG. 1 is a block diagram of an example of a distributed computing environment 100 for migrating container workloads based on energy consumption according to some aspects of the present disclosure. The distributed computing environment 100, such as a data grid or a computing cluster, can be positioned at any suitable geographical location and may form any suitable part of a network infrastructure. For example, the distributed computing environment 100 can be or include an edge computing system positioned at a physical edge of a network infrastructure. Components within the distributed computing environment 100 may communicate using a network 130, such as the Internet or a local area network (LAN). The distributed computing environment 100 can include a migration engine 120 and nodes 110a-c. The nodes 110a-c can be responsible for data processing, analysis, storage, or a combination thereof within the distributed computing environment 100. Examples of the nodes 110a-c can include servers, desktop computers, laptop computers, mobile phones, wearable devices such as smart watches, networking hardware (e.g., gateways, firewalls, and routers), or any combination of these.

A container 108a can be executing on a node 110a. The node 110a can allocate computing resources, such as central processing unit (CPU) power, memory, and storage, to the container 108a to enable execution of the container 108a. As a result of executing the container 108a, one or more workloads 114 (e.g., tasks or processes associated with containerized applications) of the container 108a can be carried out. In a particular example, the node 110a can be a smartphone, tablet, wearable device, vehicle, or other suitable device characterized by inherent mobility. Data from data services can be used at the node 110a to perform tasks. For example, the node 110a may derive meaningful insights of an environment or situation, identify patterns, detect anomalies, etc. from the data. To facilitate the data retrieval from the data services, the container 108a can be deployed at the node 110a with a set of API contracts. The API contracts can define communication protocols between data services within an access range of the node 110a and the node 110a. For example, a data service may be configured to provide temperature data. A corresponding API contract may specify a frequency at which temperature data should be transmitted to the node 110a by the data service, a threshold for or range of desired temperature values, or include other suitable specifications for the communication between the data service and the node 110a.

In using computing resources and carrying out workloads (e.g., executing APIs based on the API contracts), the container 108a can consume electrical energy. The migration engine 120 may quantify and monitor energy consumption by the container 108a and adjust container operations accordingly to improve (e.g., optimize) energy consumption within the distributed computing environment 100 and improve container performance. For example, the migration engine 120 may generate an energy consumption estimate 102 for the container 108a. The energy consumption estimate 102 can be based on computing resource usage (e.g., central processing unit (CPU) usage and memory usage) of the container 108a, a volume of clients of the container 108a, and network traffic with respect to the container 108a. Thus, the migration engine 120 can quantify energy consumption by the container 108a based on processing and networking activity associated with the containers 108a.

For example, the migration engine 120 can estimate the CPU usage and memory usage of the container 108a based on the workloads 114 of the container 108a. A number of API contracts can be used to estimate CPU usage of the container 108a. An amount of data estimated to be retrieved by each API based on each API contract can be used to estimate memory usage of the container 108a. Further, in some examples, execution of the container 108a at the node 110a can be monitored to generate data indicative of computing resource usage, the volume of clients of the container 108a, the network traffic with respect to the container 108a, or a combination thereof. Then, the data can be used by the migration engine 120 to generate the energy consumption estimate 102. For example, the migration engine 120 may train a machine learning algorithm to predict energy consumption by the container 108a based on the data.

In some examples, energy consumption by the container 108a may change overtime. For example, increases in network traffic or user volume can increase computing resources required by the container 108a, which in turn increases energy consumption by the container 108a. The migration engine 120 may communicate with the node 110a to monitor energy consumption of the container 108a over time, which can allow the migration engine 120 to detect changes in energy consumption and update the energy consumption estimate 102 accordingly. The migration engine 120 may also generate a historical energy profile for the container 108a indicative of energy consumption by the container 108a over a prior time window.

The migration engine 120 may further determine (e.g., receive or generate) an energy consumption threshold 104. The energy consumption threshold 104 can be a value below which the container 108a can execute efficiently, below which the container 108a can have a reasonable energy impact on the node 110a, or a combination thereof. For example, an energy consumption estimate above the energy consumption threshold 104 can indicate overloading of the container 108a. That is, energy consumption above the energy consumption threshold 104 can indicate that the workloads 114 of the container 108a are too demanding for an amount of computing resources allocated to the container, which can lead to poor performance and latency for the workloads 114.

In an example, the migration engine 120 may determine that the energy consumption estimate 102 for the container 108a exceeds the energy consumption threshold 104. The excess energy consumption may be due to high user volume associated with the container 108a. Due to the energy consumption estimate 102 exceeding the energy consumption threshold 104, the migration engine 120 may identify another node within the distributing computing environment 100 that is compatible with the container 108a.

To do so, the migration engine 120 may first identify nodes 110b-c with sufficient computing resources for handling the first container 108a. The migration engine 120 may then determine current workloads 106a-b, predicted workloads 118a-b, energy levels 122b-c, or a combination thereof of the nodes 110b-c. To determine predicted workloads 118a-b, the migration engine 120 can determine historical workloads performed at each of the nodes 110b-c. The migration engine 120 can then predict workloads 118b-c to be performed at the nodes 110a-c based on the historical workloads, for example using a predictive forecasting algorithm. The migration engine 120 can then determine which of the nodes 110b-c is best suited for deploying the container 108a based on the current workloads 106a-b, predicted workloads 118a-b, energy levels 122b-c, or any combination thereof of the nodes 110b-c. The node best suited for the deploying the container 108a can be the node at which energy consumption by the container 108a is minimized, container performance is optimized, or a combination thereof.

As one specific example, the migration engine 120 may determine that a second node 110b is best suited for deploying the container 108a based on the current workload 106a of the second node 110b being less computing resource intensive than the current workload 106b of the third node 110c. Additionally or alternatively, the migration engine 120 may determine that the second node 110b is best suited for deploying the container 108a based on a predicted workload 118a of the second node 110b being less computing resource intensive than another predicted workload 118b of the third node 110c, or based on an energy level 122b (e.g., a battery power) of the second node 110b being greater than another energy level 122c of the third node 110c.

Additionally, in some examples, the migration engine 120 can implement a multi-objective optimization algorithm 124 to determine which node is best suited for deploying the container 108a. Examples of the multi-objective optimization algorithm 124 can include a Non-dominated Sorting Genetic Algorithm (NSGA) or a Multi-Objective Particle Swarm Optimization Algorithm (MOPSO). The multi-objective optimization algorithm 124 can be configured to output (e.g., predict) the node at which energy consumption by the container 108a can be minimized and at which one or more performance metrics of the container 108a can be optimized. Optimizing a matric can involve minimizing or maximizing the metric, depending on the goal and metric. Examples of performance metrics the multi-objective optimization algorithm 124 may be configured to optimize for the container 108a can include CPU usage, memory usage, network throughput, latency, error rates, and overallocation of computing resources.

In an example, the migration engine 120 can input to the multi-objective optimization algorithm 124 a set of candidate solutions (e.g., nodes 110b-c). The multi-object optimization algorithm 124 can further receive, from the migration engine 120, current energy levels 122b-c, predicted workloads 118b-c, current workloads 106a-b, or a combination thereof of the nodes 110b-c. Additionally, the multi-objective optimization algorithm 124 can receive the energy consumption estimate 102 from the migration engine 120. The multi-objective optimization algorithm 124 can be configured to evaluate the nodes 110b-c based on the information from the migration engine 120. In doing so, the multi-objective optimization algorithm 124 can predict energy consumption by the container 108a at each of the nodes 110b-c and can predict the performance metrics of the container 108a at each of the nodes 110b-c. The output of the multi-objective optimization algorithm 124 can then be node at which the predicted energy consumption and performance metrics of the container are optimized.

For example, the multi-objective optimization algorithm 124 can generate a prediction indicating that energy consumption by the container 108a at the second node 110b may be less than energy consumption by the container 108a at the third node 110c. The multi-objective optimization algorithm 124 can also generate a prediction indicating that latency of the container 108a at the second node 110b may be less than latency of the container 108a at the third node 110c. To generate the predictions, the migration engine 120 can determine (e.g., receive or generate) objective functions for each value (e.g., each performance metric or energy consumption) being optimized. Each objective function can output an estimate of a respective value based on one or more variables. For example, the energy consumption estimate 102, CPU usage, memory usage, and a volume of clients for the container 108a as well as current workloads 106a-b of the nodes 110a-b can be used to output an estimate of energy consumption for the container 108a at each node 110b-c. The multi-objective optimization algorithm 124 may then be configured to compare objective function outputs for each node to determine the node at which energy consumption and performance is optimized. Thus, due to the predictions (e.g., the outputs of the objective functions) indicating energy consumption and latency for the container 108a will be minimized at the second node 110b, the multi-objective optimization algorithm 124 can output the second node 110b.

In some examples, the predictions generated by the multi-objective optimization algorithm 124 can be for a time window due to energy consumption and workloads for nodes changing overtime. For example, node 110b may be the optimal solution for deploying the container 108a for a period of time (e.g., one hour), but due to shifting workloads, the node 110b may no longer be the optimal solution after the period of time. Thus, upon expiration of the period of time, the migration engine 120 may execute the multi-objective optimization algorithm 124 again. The multi-objective optimization algorithm 124 may then output another node or may output the second node 110b a second time. By reevaluating the nodes 110a-c via the multi-objective optimization algorithm 124 periodically, the migration engine 120 can maintain optimal execution of and energy consumption by the container 108a.

Constraints can also be implemented as part of the multi-objective optimization algorithm 124. For example, an energy level threshold 112, a storage threshold, or other suitable constraints can be implemented. As a result, implementing the multi-objective optimization algorithm 124 can include identifying the node that optimizes energy consumption, optimizes one or more performance metrics, and satisfies the constraints. For example, the energy level threshold 112 may provide a battery life length (e.g., one, three, or five hours) or battery power percentage which the node 110b is required to meet or exceed for the container 108a to be deployed. Additionally, the node 110b can be required to have storage capacity meeting or exceeding the storage threshold. As a result, the migration engine 120 can ensure that the second node 110b identified using the multi-objective optimization algorithm 124 has sufficient power and computing resources for the container 108a.

In response to identifying that the second node 110b is best suited for the first container 108, the migration engine 120 can automatically deploy the first container 108a at the second node 110b. The migration engine 120 may also modify one or more network protocols 116 associated with the container 108a to limit energy consumption by the container 108a at the second node 110b. The network protocols 116 can define how data is transmitted or received by the container 108a other suitable aspects of communication between the container 108a and components of the distributed computing environment 100. For example, a network protocol for the container 108a can provide a frequency of transmission of a keep-alive mechanism (e.g., a keep-alive ping) to a data service. The purpose of the transmission of the keep-alive ping can be to determine whether the data service is within an access range of a node on which the container 108a is deployed. The container 108a can be updated to deactive an API if the data service is out of range. In another example, a network protcol can define a data transfer frequency, which can be the frequency at which the container 108a receives or transmits data from a data service. In the above examples, the migration engine 120 can modify the network protocols (e.g., a parameter thereof) to limit energy consumption by the container 108a at the second node 110b. For example, the migration engine 120 can decrease a transmission frequency of keep-alive pings by the container, decrease a data transfer frequency of the container 108a, or a combination thereof.

In some examples, after deploying the container 108a at the second node 110b, the container 108a can be terminated at the first node 110a. Alternatively, the container 108a can be executed at both nodes 110a-b. For example, a first portion of the workloads 114 can be executed via the container 108a at the first node 110a and a second portion of the workloads 114 can be executed via the container 108a at the second node 110b. Splitting the workloads 114 can decrease energy consumption by the container 108a at each of the nodes 110a-b.

Additionally, or alternatively, subsequent to deploying the container 108a at the second node 110b, the migration engine 120 may deploy a second container 108b at the second node 110b. The migration engine 120 may then migrate a portion of the workloads 114 to the second container 108b. In doing so, the migration engine 120 can decrease computing resource requirements of the container 108a and energy consumption by the container 108a. Thus, the container 108a may execute more efficiently at the first node 110a following the migration of the portion of the workloads 114 to the second container 108b. To determine which of the workloads 114 to transfer, the migration engine 120 may generate energy consumption estimates for each workload of the container 108a. In the particular example, an amount of data estimated to be retrieved by each API or other suitable aspects of executing the workloads 114 of the container 108a can be used to generate the energy consumption estimates for the workloads 114. Then, workloads estimated to have high energy requirements (e.g., energy consumption estimates that meet or exceed a predefined threshold) can be transferred to the second container 108b. Additionally, to determine which container to transfer the workload to, the migration engine 120 may receive historical energy profiles indicative of energy consumption for a group of containers and select a container with low energy requirements.

In another example, the migration engine 120 may detect an energy level 122a of the node 110a and may determine that the energy level 122a is below an energy level threshold 112. In response, the migration engine 120 may detect a second energy level 122b of the second node 110b and a third energy level 122c of the third node 110c. The migration engine 120 may determine that one or both of the nodes 110b-c have an energy level exceeding the energy level threshold 112. If, for example, only the second node 110b has an energy level exceeding the energy level threshold 112, the migration engine may automatically deploy the container 108a at the second node 110b. Alternatively, if the migration engine 120 detects more than one node with energy levels exceeding the energy level threshold 112, the migration engine 120 may further analyze current workloads 106a-b, predicted workloads 118a-b, or a combination thereof of the nodes 110b-c.

While FIG. 1 depicts a specific arrangement of components, other examples can include more components, fewer components, different components, or a different arrangement of the components shown in FIG. 1. For instance, in other examples, the migration engine 120 may be positioned within one of the nodes 110a-c.

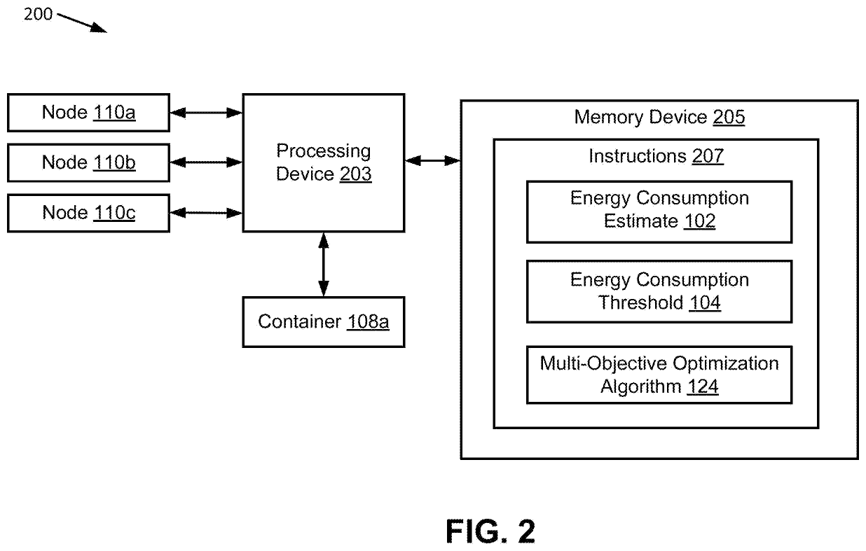

FIG. 2 is a block diagram of another example of a distributed computing environment 200 for migrating container workloads based on energy consumption according to some aspects of the present disclosure. The distributed computing environment 200 depicted in FIG. 2 includes a processing device 203 communicatively coupled with a memory device 205. As depicted in FIG. 2, the processing device 203 and the memory device 205 can be part of an edge node, such as a first node 110a.

The processing device 203 can include one processing device or multiple processing devices. Non-limiting examples of the processing device 203 include a Field-Programmable Gate Array (FPGA), an application-specific integrated circuit (ASIC), a microprocessor, etc. The processing device 203 can execute instructions 207 stored in the memory device 205 to perform operations. In some examples, the instructions 207 can include processor-specific instructions generated by a compiler or an interpreter from code written in any suitable computer-programming language, such as C, C++, C#, etc.

The memory device 205 can include one memory or multiple memories. The memory device 205 can be non-volatile and may include any type of memory that retains stored information when powered off. Non-limiting examples of the memory device 205 include electrically erasable and programmable read-only memory (EEPROM), flash memory, or any other type of non-volatile memory. At least some of the memory can include a non-transitory computer-readable medium from which the processing device 203 can read instructions 207. The non-transitory computer-readable medium can include electronic, optical, magnetic, or other storage devices capable of providing the processing device with computer-readable instructions or other program code. Examples of the non-transitory computer-readable medium include magnetic disk(s), memory chip(s), ROM, RAM, an ASIC, a configured processor, optical storage, or any other medium from which a computer processor can read the instructions 207.

In some examples, the processing device 203 can generate an energy consumption estimate 102 for a container 108a executing on a first node 110a of a plurality of nodes 110a-c. The processing device 203 can further determine that the energy consumption estimate 102 of the container 108a exceeds an energy consumption threshold 104. In response to determining that the energy consumption estimate 102 exceeds the energy consumption threshold 104, the processing device 203 can implement a multi-objective optimization algorithm 124 to identify a second node 110b from the plurality of nodes 110a-c usable to execute the container 108a based at least in part on a current workload of each of the nodes 110a-c and the energy consumption estimate 102 of the container 108a. Then, in response to identifying the second node 110b, the processing device 203 can deploy the container 108a at the second node 110b.

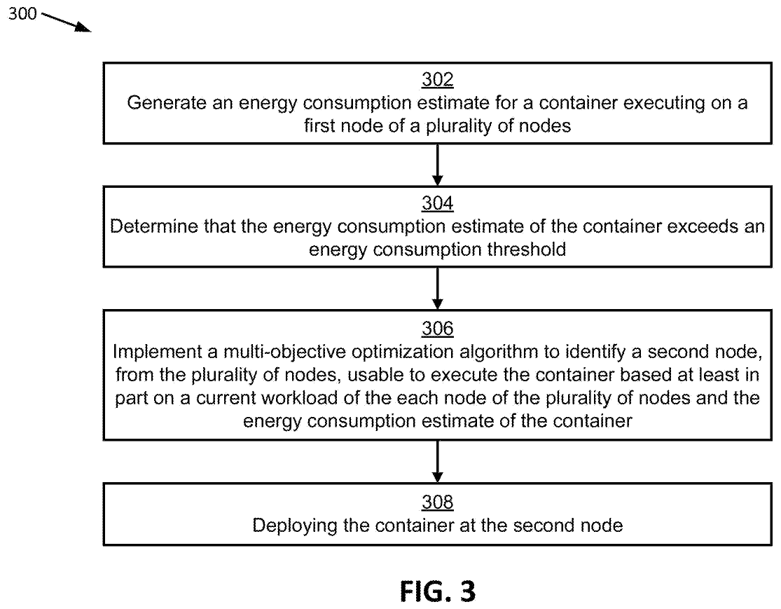

FIG. 3 is a flowchart of a process 300 for migrating containers based on energy-consumption rates to facilitate energy-efficient deployment of containers at target devices according to some aspects of the present disclosure. In some examples, the processing device 203 can implement some or all of the steps shown in FIG. 3. For example, the processing device 203 execute the migration engine 106 of FIG. 1 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 203 can generate an energy consumption estimate 102 for a container 108a that is executing on a first node 110a of a plurality of nodes 110a-c. The processing device 203 can generate the energy consumption estimate 102 based on computing resource usage (e.g., central processing unit (CPU) usage and memory usage) of the container 108a, a volume of client of the container 108a, and network traffic with respect to the container 108a. For example, execution of the container 108a at the node 110a can be monitored to generate data indicative of computing resource usage, the volume of clients of the container 108a, the network traffic with respect to the container 108a, or a combination thereof. Then, the data can be used by the migration engine 120 to generate the energy consumption estimate 102. By monitoring and considering various aspects of executing the container 108a at the node 110a, the energy consumption estimate 102 can be highly accurate.

At block 304, the processing device 203 can determine that the energy consumption estimate 102 of the container exceeds an energy consumption threshold 104, which may be predefined and user customizable. The energy consumption threshold 104 can be a value below which the container 108a can execute efficiently and below which the container 108a can have a reasonable impact on the node 110a. By exceeding the energy consumption threshold 104, the energy consumption estimate 102 can indicate overloading of the container 108a. That is, energy consumption of the container 108a may be too demanding for an amount of computing resources allocated to the container by the node 110a. This can lead to poor performance and latency for workloads of the container 108a.

At block 306, the processing device 203 can implement a multi-objective optimization algorithm 124 to identify a second node 110b, from the plurality of nodes 110a-b, that can be used to execute the container 108a based at least in part on a current workload of the each node of the plurality of nodes 110a-c and the energy consumption estimate 102 of the container 108a. For example, the processing device 203 can initialize the multi-objective optimization algorithm 124 with potential solutions (e.g., nodes 110a-c) to the optimization problem. The optimization problem can involve determining at which node container energy consumption and one or more performance metrics of the container 108a can be optimized. The multi-object optimization algorithm 124 can use data indicative of current workloads or other suitable characteristics of the nodes 110a-c and the energy consumption estimate 102 of the container to evaluate each of the nodes' 110a-c ability to handle the container 108a. The multi-objective optimization algorithm 124 can then output a prediction that the second node 110b is best suited for deploying the container 108a. That is, the multi-objective optimization algorithm 124 can predict that the energy consumption by the container 108a and/or the performance metrics of the container 108a will be optimized at the second node 110b.

At block 308, the processing device 203 can deploy the container 108a at the second node 110b (e.g., migrate the container 108a to the second node 110b). To do so, the processing device 203 may transfer runtime configurations and data of the container 108a to the second node 110b. As a result, the container 108a can then be executed at the second node 110b with minimal disruption to the retrieval of data from the data services to facilitate better performance of the container 108a and optimize energy consumption.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device that includes instructions executable by the processing device for causing the processing device to perform operations comprising:
generating an energy consumption estimate for a container executing on a first node of a plurality of nodes;
determining that the energy consumption estimate of the container meets or exceeds an energy consumption threshold;
in response to determining that the energy consumption estimate meets or exceeds the energy consumption threshold, executing a multi-objective optimization algorithm configured to identify a second node from the plurality of nodes usable to execute the container based at least in part on a current workload of each node of the plurality of nodes and the energy consumption estimate of the container; and
in response to identifying the second node, deploying the container at the second node.

2. The system of claim 1, wherein the operations further comprise:
in response to determining that the energy consumption estimate exceeds the energy consumption threshold, modifying at least one network protocol associated with the container to limit energy consumption by the container.

3. The system of claim 2, wherein modifying the at least one network protocol associated with the container comprises:
modifying a transmission frequency of a keep-alive mechanism; and
modifying a data transfer frequency.

4. The system of claim 1, wherein the multi-objective optimization algorithm is further configured to identify the second node from the plurality of nodes based on a respective predicted workload of each node of the plurality of nodes and a respective energy level of each node of the plurality of nodes.

5. The system of claim 1, wherein the operations further comprise:
detecting a first energy level of the second node;
determining that the first energy level of the second node is below an energy level threshold;
in response to determining that the first energy level of the second node is below the energy level threshold, identifying a third node from the plurality of nodes with a second energy level exceeding the energy level threshold; and
in response to identifying the third node, deploying the container at the third node.

6. The system of claim 1, wherein the container is a first container, and wherein the operations further comprise:
in response to determining that the energy consumption estimate of the container meets or exceeds the energy consumption threshold, analyzing historical energy profiles of each container of a plurality of containers, the plurality of containers comprising at least the first container and a second container, and the historical energy profiles being indicative of energy consumption of each container of the plurality of containers; and
determining, based on the historical energy profiles, that energy consumption by the second container is less than energy consumption by the first container.

7. The system of claim 6, wherein the operations further comprise:
subsequent to deploying the first container at the second node, deploying the second container at the second node and transferring at least one workload of the first container to the second container.

8. A method comprising:
generating, by a processing device, an energy consumption estimate for a container executing on a first node of a plurality of nodes;
determining, by the processing device, that the energy consumption estimate of the container meets or exceeds an energy consumption threshold;
in response to determining that the energy consumption estimate meets or exceeds the energy consumption threshold, executing, by the processing device, a multi-objective optimization algorithm to identify a second node, from the plurality of nodes, usable to execute the container based at least in part on a current workload of each node of the plurality of nodes and the energy consumption estimate of the container; and
in response to identifying the second node, deploying, by the processing device, the container at the second node.

9. The method of claim 8, further comprising:
in response to determining that the energy consumption estimate exceeds the energy consumption threshold, modifying at least one network protocol associated with the container to limit energy consumption by the container.

10. The method of claim 9, wherein modifying the at least one network protocol associated with the container comprises:
modifying a transmission frequency of a keep-alive mechanism; and
modifying a data transfer frequency.

11. The method of claim 8, wherein the multi-objective optimization algorithm is further configured to identify the second node from the plurality of nodes based on a respective predicted workload of each node of the plurality of nodes and a respective energy level of each node of the plurality of nodes.

12. The method of claim 8, further comprising:
detecting a first energy level of the second node;
determining that the first energy level of the second node is below an energy level threshold;
in response to determining that the first energy level of the second node is below the energy level threshold, identifying a third node from the plurality of nodes with a second energy level exceeding the energy level threshold; and
in response to identifying the third node, deploying the container at the third node.

13. The method of claim 8, wherein the container is a first container, and wherein the method further comprises:
in response to determining that the energy consumption estimate of the container exceeds the energy consumption threshold, analyzing historical energy profiles of each container of a plurality of containers, the plurality of containers comprising at least the first container and a second container, and the historical energy profiles being indicative of energy consumption of each container of the plurality of containers; and
determining, based on the historical energy profiles, that energy consumption by the second container is less than energy consumption by the first container.

14. The method of claim 13, further comprising:
subsequent to deploying the first container at the second node, deploying the second container at the second node and transferring at least one workload of the first container to the second container.

15. A non-transitory computer-readable medium comprising instructions that are executable by a processing device for causing the processing device to perform operations comprising:
generating an energy consumption estimate for a container executing on a first node of a plurality of nodes;
determining that the energy consumption estimate of the container meets or exceeds an energy consumption threshold;
in response to determining that the energy consumption estimate meets or exceeds the energy consumption threshold, executing a multi-objective optimization algorithm to identify a second node, from the plurality of nodes, usable to execute the container based at least in part on a current workload of the second node and the energy consumption estimate of the container; and
in response to identifying the second node, deploying the container at the second node.

16. The non-transitory computer-readable medium of claim 15, wherein the operations further comprise:
in response to determining that the energy consumption estimate meets or exceeds the energy consumption threshold, modifying at least one network protocol associated with the container to limit energy consumption by the container.

17. The non-transitory computer-readable medium of claim 16, wherein modifying the at least one network protocol associated with the container comprises:
modifying a transmission frequency of a keep-alive mechanism; and
modifying a data transfer frequency.

18. The non-transitory computer-readable medium of claim 15, wherein the multi-objective optimization algorithm is further configured to identify the second node from the plurality of nodes based on a respective predicted workload of each node of the plurality of nodes and a respective energy level of each node of the plurality of nodes.

19. The non-transitory computer-readable medium of claim 15, wherein the operations further comprise:
detecting a first energy level of the second node;
determining that the first energy level of the second node is below an energy level threshold;
in response to determining that the first energy level of the second node is below the energy level threshold, identifying a third node from the plurality of nodes with a second energy level exceeding the energy level threshold; and
in response to identifying the third node, deploying the container at the third node.

20. The non-transitory computer-readable medium of claim 15, wherein the container is a first container, and wherein the operations further comprise:
in response to determining that the energy consumption estimate of the container exceeds the energy consumption threshold, analyzing historical energy profiles of each container of a plurality of containers, the plurality of containers comprising at least the first container and a second container, and the historical energy profiles being indicative of energy consumption of each container of the plurality of containers; and
determining, based on the historical energy profiles, that energy consumption by the second container is less than energy consumption by the first container; and
in response to determining that the energy consumption by the second container is less than the energy consumption by the first container, deploying the second container at the second node and transferring at least one workload of the first container to the second container.
